(19) United States
(12) Patent Application Publication
(10) Pub. No.: US 2017/0100887 A1
(43) Pub. Date: Apr. 13, 2017

(54) FUSED FILAMENT FABRICATION MATERIALS AND METHODS OF USE THEREOF

(71) Applicant: EMPIRE TECHNOLOGY DEVELOPMENT LLC, Wilmington, DE (US)

(72) Inventor: James Y. WANG, Beijing (CN)

(73) Assignee: EMPIRE TECHNOLOGY DEVELOPMENT LLC, Wilmington, DE (US)

(21) Appl. No.: 15/317,904

(22) PCT Filed: Jun. 9, 2014
(86) PCT No.: PCT/CN2014/079507

§ 371 Date: Dec. 9, 2016

(51) Int. Cl. B29C 67/00; C08K 5/098; B33Y 70/00; B33Y 80/00; B29C 35/16; B33Y 10/00

(52) U.S. Cl. CPC B29C 67/0055; B29C 35/16; B33Y 10/00; B33Y 70/00; B33Y 80/00; C08K 5/098; B29K 2101/12

(57) ABSTRACT

A composition for fused filament fabrication includes at least one thermoplastic material, maleic anhydride, at least one fatty acid salt, and at least one radical initiator; at least one thermoplastic material and at least one ionomer; or at least one thermoplastic material and at least one copolymer of methacrylic acid and an olefin. An article having a plurality of layers may be made, wherein at least one layer is formed by depositing the composition for fused filament fabrication. A method of preparing an article includes depositing a plurality of layers to form an article, wherein at least one layer includes the composition for fused filament fabrication.

### BACKGROUND

Fused filament fabrication is a type of additive manufacturing or 3-dimensional printing. Materials used for fused filament fabrication are typically thermoplastic polymers in the form of filaments. The filaments are melted in a “printer” head and extruded onto a deposition surface, and form a solid layer upon cooling. Multiple layers are deposited one atop the other. The complete ensemble of the layers forms a 3-dimensional article. The interface between the layers of the object may be weak, and delamination may occur. Thus, there is a need for a material for use in fused filament fabrication that provides improved interlayer strength in an article.

### SUMMARY

In an embodiment, a composition for fused filament fabrication includes at least one thermoplastic material, maleic anhydride, at least one fatty acid salt, and at least one radical initiator.

In an embodiment, an article has a plurality of layers, wherein at least one layer is formed by depositing a composition for fused filament fabrication including at least one thermoplastic material, maleic anhydride, at least one fatty acid salt, and at least one radical initiator.

In an embodiment, a method of preparing an article includes depositing a plurality of layers to form an article, wherein at least one layer includes a composition including at least one thermoplastic material, maleic anhydride, at least one fatty acid salt, and at least one radical initiator.

In an embodiment, a composition for fused filament fabrication includes at least one thermoplastic material and at least one ionomer.

In an embodiment, an article has a plurality of layers, wherein at least one layer is formed by depositing a composition for fused filament fabrication including at least one thermoplastic material and at least one ionomer.

In an embodiment, a method of preparing an article includes depositing a plurality of layers to form an article, wherein at least one layer includes a composition including at least one thermoplastic material and at least one ionomer.

In an embodiment, a composition for fused filament fabrication includes at least one thermoplastic material and at least one copolymer of methacrylic acid and an olefin.

In an embodiment, an article includes a plurality of layers, wherein at least one layer is formed by depositing a composition for fused filament fabrication including at least one thermoplastic material and at least one copolymer of methacrylic acid and an olefin.

In an embodiment, a method of preparing an article includes depositing a plurality of layers to form an article, wherein at least one layer includes a composition including at least one thermoplastic material and at least one copolymer of methacrylic acid and an olefin.

### BRIEF DESCRIPTION OF THE DRAWINGS

The drawing submitted herewith shows some embodiments or features of some embodiments encompassed by the disclosure. The drawing is meant to be illustrative and is not intended to be limiting.

FIG. 1 is a cross-sectional view of a 3-dimensional article having two layers prepared in accordance with some embodiments.

FIG. 2 is a cross-sectional view of a 3-dimensional article having more than two layers prepared in accordance with some embodiments.

### DETAILED DESCRIPTION

Embodiments described herein provide compositions for use in fused filament fabrication that are practical, economical, and result in the production of articles having greater interlayer strength than the interlayer strength of articles produced using typical fused fabrication materials.

This disclosure is not limited to the particular systems, devices, and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In some embodiments, a composition for fused filament fabrication includes at least one thermoplastic material and at least one of maleic anhydride, at least one fatty acid salt, at least one radical initiator, at least one ionomer, at least one copolymer of methacrylic acid and an olefin, at least one processing aid, and at least one compatibilizer, and combinations thereof. In some embodiments, a composition for fused filament fabrication includes at least one thermoplastic material, maleic anhydride, at least one fatty acid salt, and at least one radical initiator. In some embodiments, a composition for fused filament fabrication includes at least one thermoplastic material, maleic anhydride, at least one fatty acid salt, at least one radical initiator, and at least one processing aid. In some embodiments, a composition for fused filament fabrication includes at least one thermoplastic material, maleic anhydride, at least one fatty acid salt, at least one radical initiator, and at least one compatibilizer. In some embodiments, a composition for fused filament fabrication includes at least one thermoplastic material, maleic anhydride, at least one fatty acid salt, at least one radical initiator, at least one processing aid, and at least one compatibilizer. In some embodiments, a composition for fused filament fabrication includes at least one thermoplastic material and at least one ionomer. In some embodiments, a composition for fused filament fabrication includes at least one thermoplastic material, at least one ionomer, and at least one processing aid. In some embodiments, a composition for fused filament fabrication includes at least one thermoplastic material, at least one ionomer, and at least one compatibilizer. In some embodiments, a composition for fused filament fabrication includes at least one thermoplastic material, at least one ionomer, at least one processing aid, and at least one compatibilizer. In some embodiments, a composition for fused filament fabrication includes at least one thermoplastic material and at least one copolymer of methacrylic acid and an olefin. In some embodiments, a composition for fused filament fabrication includes at least one thermoplastic material, at least one copolymer of methacrylic acid and an olefin, and at least one processing aid. In some embodiments, a composition for fused filament fabrication includes at least one thermoplastic material, at least one copolymer of methacrylic acid and an olefin, and at least one compatibilizer. In some embodiments, a composition for fused filament fabrication includes at least one thermoplastic material, at least one copolymer of methacrylic acid and an olefin, at least one processing aid, and at least one compatibilizer.

In some embodiments, an article having a plurality of layers may be made, wherein at least one layer is formed by depositing a composition for fused filament fabrication including at least one thermoplastic material and at least one of maleic anhydride, at least one fatty acid salt, at least one radical initiator, at least one ionomer, at least one copolymer of methacrylic acid and an olefin, at least one processing aid, and at least one compatibilizer, and combinations thereof. Each deposited layer is at least partially in contact with one other layer. That is, each layer will at least partially contact at least a portion of at least one other layer. Any given layer may be in contact with part or all of more than one layer. In some embodiments, an article having a plurality of layers may be made, wherein at least one layer is formed by depositing a composition for fused filament fabrication including at least one thermoplastic material, maleic anhydride, at least one fatty acid salt, and at least one radical initiator. In some embodiments, an article having a plurality of layers may be made, wherein at least one layer is formed by depositing a composition for fused filament fabrication including at least one thermoplastic material, maleic anhydride, at least one fatty acid salt, at least one radical initiator, and at least one processing aid. In some embodiments, an article having a plurality of layers may be made, wherein at least one layer is formed by depositing a composition for fused filament fabrication including at least one thermoplastic material, maleic anhydride, at least one fatty acid salt, at least one radical initiator, and at least one compatibilizer. In some embodiments, an article having a plurality of layers may be made, wherein at least one layer is formed by depositing a composition for fused filament fabrication including at least one thermoplastic material, maleic anhydride, at least one fatty acid salt, at least one radical initiator, at least one processing aid, and at least one compatibilizer. In some embodiments, an article having a plurality of layers may be made, wherein at least one layer is formed by depositing a composition for fused filament fabrication including at least one thermoplastic material and at least one ionomer. In some embodiments, an article having a plurality of layers may be made, wherein at least one layer is formed by depositing a composition for fused filament fabrication including at least one thermoplastic material, at least one ionomer, and at least one processing aid. In some embodiments, an article having a plurality of layers may be made, wherein at least one layer is formed by depositing a composition for fused filament fabrication including at least one thermoplastic material, at least one ionomer, and at least one compatibilizer. In some embodiments, an article having a plurality of layers may be made, wherein at least one layer is formed by depositing a composition for fused filament fabrication including at least one thermoplastic material, at least one ionomer, at least one processing aid, and at least one compatibilizer. In some embodiments, an article having a plurality of layers may be made, wherein at least one layer is formed by depositing a composition for fused filament fabrication including at least one thermoplastic material and at least one copolymer of methacrylic acid and an olefin. In some embodiments, an article having a plurality of layers may be made, wherein at least one layer is formed by depositing a composition for fused filament fabrication including at least one thermoplastic material, at least one copolymer of methacrylic acid and an olefin, and at least one processing aid. In some embodiments, an article having a plurality of layers may be made, wherein at least one layer is formed by depositing a composition for fused filament fabrication including at least one thermoplastic material, at least one copolymer of methacrylic acid and an olefin, and at least one compatibilizer. In some embodiments, an article having a plurality of layers may be made, wherein at least one layer is formed by depositing a composition for fused filament fabrication including at least one thermoplastic material, at least one copolymer of methacrylic acid and an olefin, at least one processing aid, and at least one compatibilizer.

In some embodiments, a method of preparing an article includes depositing a plurality of layers to form an article, wherein at least one layer includes a composition including at least one thermoplastic material and at least one of maleic anhydride, at least one fatty acid salt, at least one radical initiator, at least one ionomer, at least one copolymer of methacrylic acid and an olefin, at least one processing aid, and at least one compatibilizer, and combinations thereof. Each deposited layer is at least partially in contact with one other layer. That is, each layer will at least partially contact at least a portion of at least one other layer. Any given layer may be in contact with part or all of more than one layer. In some embodiments, a method of preparing an article includes depositing a plurality of layers to form an article, wherein at least one layer includes a composition including at least one thermoplastic material, maleic anhydride, at least one fatty acid salt, and at least one radical initiator. In some embodiments, a method of preparing an article includes depositing a plurality of layers to form an article, wherein at least one layer includes a composition including at least one thermoplastic material, maleic anhydride, at least one fatty acid salt, at least one radical initiator, and at least one processing aid. In some embodiments, a method of preparing an article includes depositing a plurality of layers to form an article, wherein at least one layer includes a composition including at least one thermoplastic material, maleic anhydride, at least one fatty acid salt, at least one radical initiator, and at least one compatibilizer. In some embodiments, a method of preparing an article includes depositing a plurality of layers to form an article, wherein at least one layer includes a composition including at least one thermoplastic material, maleic anhydride, at least one fatty acid salt, at least one radical initiator, at least one processing aid, and at least one compatibilizer. In some embodiments, a method of preparing an article includes depositing a plurality of layers to form an article, wherein at least one layer includes a composition including at least one thermoplastic material and at least one ionomer. In some embodiments, a method of preparing an article includes depositing a plurality of layers to form an article, wherein at least one layer includes a composition including at least one thermoplastic material, at least one ionomer, and at least one processing aid. In some embodiments, a method of preparing an article includes depositing a plurality of layers to form an article, wherein at least one layer includes a composition including at least one thermoplastic material, at least one ionomer, and at least one compatibilizer. In some embodiments, a method of preparing an article includes depositing a plurality of layers to form an article, wherein at least one layer includes a composition including at least one thermoplastic material, at least one ionomer, at least one processing aid, and at least one compatibilizer. In some embodiments, a method of preparing an article includes depositing a plurality of layers to form an article, wherein at least one layer includes a composition including at least one thermoplastic material and at least one copolymer of methacrylic acid and an olefin. In some embodiments, a method of preparing an article includes depositing a plurality of layers to form an article, wherein at least one layer includes a composition including at least one thermoplastic material, at least one copolymer of methacrylic acid and an olefin, and at least one processing aid. In some embodiments, a method of preparing an article includes depositing a plurality of layers to form an article, wherein at least one layer includes a composition including at least one thermoplastic material, at least one copolymer of methacrylic acid and an olefin, and at least one compatibilizer. In some embodiments, a method of preparing an article includes depositing a plurality of layers to form an article, wherein at least one layer includes a composition including at least one thermoplastic material, at least one copolymer of methacrylic acid and an olefin, at least one processing aid, and at least one compatibilizer.

In some embodiments, the composition for fused filament fabrication includes at least one thermoplastic material. As used herein, “thermoplastic material” refers to a polymer which becomes pliable or moldable above a specific temperature and returns to a solid state upon cooling. Any suitable thermoplastic material(s) may be used in any embodiment. A thermoplastic material may be selected based on its softening temperature, which may render the thermoplastic material suitable for its intended application. In some embodiments, the at least one thermoplastic material includes acrylonitrile-butadiene styrene, poly lactic acid, polyolefin, polyamide, polycarbonate, polyphenylsulfone, polyetherimide, or combinations thereof. In some embodiments, the thermoplastic material includes acrylonitrile-butadiene styrene. In some embodiments, the composition includes about 100 parts by weight of the thermoplastic material.

In some embodiments, the composition for fused filament fabrication includes maleic anhydride at generally any concentration. In some embodiments, the composition includes about 3 parts by weight of maleic anhydride to about 20 parts by weight of maleic anhydride. In some embodiments, the composition includes about 5 parts by weight of maleic anhydride. In some embodiments, the composition includes about 3 parts by weight of maleic anhydride, about 5 parts by weight of maleic anhydride, about 10 parts by weight of maleic anhydride, about 20 parts by weight of maleic anhydride, or any value or range of values between any two of these values, including endpoints.

In some embodiments, the composition for fused filament fabrication includes at least one fatty acid salt at generally any concentration. As used herein, “fatty acid salt” refers to a compound formed from a reaction between a fatty acid and an inorganic base or an organic base. Any suitable fatty acid salt(s) may be used in any embodiment. A fatty acid salt may be selected based on its lubricating and/or catalytic properties, which may render the fatty acid salt suitable for its intended use. In some embodiments, the at least one fatty acid salt includes sodium stearate, zinc stearate, calcium stearate, magnesium stearate, or combinations thereof. In some embodiments, the at least one fatty acid salt includes sodium stearate, zinc stearate, or combinations thereof. In some embodiments, the at least one fatty acid salt includes sodium stearate and zinc stearate. In some embodiments, the composition includes about 2 parts by weight of at least one fatty acid salt to about 10 parts by weight of at least one fatty acid salt. In some embodiments, the composition includes about 6 parts by weight of at least one fatty acid salt. In some embodiments, the composition includes about 2 parts by weight of at least one fatty acid salt, about 4 parts by weight of at least one fatty acid salt, about 6 parts by weight of at least one fatty acid salt, about 8 parts by weight of at least one fatty acid salt, at least 10 parts by weight of at least one fatty acid salt, or any value or range of values between any two of these values, including endpoints.

In some embodiments, the composition for fused filament fabrication includes at least one radical initiator at generally any concentration. As used herein, “radical initiator” refers to a substance that can produce radical species under mild conditions and promote radical reactions. Generally, a radical initiator contains weak bonds that have small bond dissociation energies. Any suitable radical initiator(s) may be used in any embodiment. A radical initiator may be selected based on its ability to decompose and/or initiate polymerization in the system under processing at the selected processing temperature. In some embodiments, the at least one radical initiator includes a peroxide initiator. In some embodiments, the at least one radical initiator includes di-t-butyl peroxide. In some embodiments, the composition includes about 0.3 parts by weight of at least one radical initiator to about 3 parts by weight of at least one radical initiator. In some embodiments, the composition includes about 1 part by weight of at least one radical initiator. In some embodiments, the composition includes about 0.3 parts by weight of at least one radical initiator, about 0.5 parts by weight of at least one radical initiator, about 1 part by weight of at least one radical initiator, about 2 parts by weight of at least one radical initiator, about 3 parts by weight of at least one radical initiator, or any value or range of values between any two of these values, including endpoints.

In some embodiments, the composition for fused filament fabrication includes at least one ionomer at generally any concentration. As used herein, “ionomer” refers to a polymer that comprises repeat units of both electrically neutral repeating units and a fraction of ionized units covalently bonded to the polymer backbone as pendant moieties. In some embodiments, the ionomer contains 15 mole percent or less of ionized units covalently bonded to the polymer backbone as pendant moieties. Any suitable ionomer(s) may be used in any embodiment. In some embodiments, the at least one ionomer includes an ethylene copolymer. In some embodiments, the composition includes about 5 parts by weight of at least one ionomer to about 30 parts by weight of at least one ionomer. In some embodiments, the composition includes about 10 parts by weight of at least one ionomer. In some embodiments, the composition includes about 5 parts by weight of at least one ionomer, about 10 parts by weight of at least one ionomer, about 15 parts by weight of at least one ionomer, about 20 parts by weight of at least one ionomer, about 25 parts by weight of at least one ionomer, about 30 parts by weight of at least one ionomer, or any value or range of values between any two of these values, including endpoints.

In some embodiments, the composition for fused filament fabrication includes at least one copolymer of methacrylic acid and an olefin at generally any concentration. As used herein, “copolymer of methacrylic acid and an olefin” refers to a polymer derived from methacrylic acid and an unsaturated hydrocarbon containing one or more pairs of carbon atoms connected by a double bond. As used herein, “olefin” refers to an unsaturated hydrocarbon containing one or more pairs of carbon atoms linked by a double bond. Any suitable copolymer of methacrylic acid and olefin(s) may be used in any embodiment. In some embodiments, the olefin includes ethylene, propylene, butylene, pentene, and combinations thereof. In some embodiments, the composition includes about 5 parts by weight of at least one copolymer of methacrylic acid and an olefin to about 30 parts by weight of at least one copolymer of methacrylic acid and an olefin. In some embodiments, the composition includes about 10 parts by weight of at least one copolymer of methacrylic acid and an olefin. In some embodiments, the composition includes about 5 parts by weight of at least one copolymer of methacrylic acid and an olefin, about 10 parts by weight of at least one copolymer of methacrylic acid and an olefin, about 15 parts by weight of at least one copolymer of methacrylic acid and an olefin, about 20 parts by weight of at least one copolymer of methacrylic acid and an olefin, about 25 parts by weight of at least one copolymer of methacrylic acid and an olefin, about 30 parts by weight of at least one copolymer of methacrylic acid and an olefin, or any value or range of values between any two of these values, including endpoints.

In some embodiments, the composition for fused filament fabrication includes at least one processing aid at generally any concentration. As used herein, “processing aid” refers to any material capable of improving the processability of a polymer. Any suitable processing aid(s) may be used in any embodiment. In some embodiments, the at least one processing aid comprises sodium stearate, calcium stearate, magnesium stearate, zinc stearate, paraffin wax, or combinations thereof. In some embodiments, the composition includes about 1 part by weight of at least one processing aid to about 5 parts by weight of at least one processing aid. In some embodiments, the composition includes about 3 parts by weight of at least one processing aid. In some embodiments, the composition includes about 1 part by weight of at least one processing aid, about 2 part by weight of at least one processing aid, about 3 parts by weight of at least one processing aid, about 4 part by weight of at least one processing aid, about 5 parts by weight of at least one processing aid, or any value or range of values between any two of these values, including endpoints.

In some embodiments, the composition for fused filament fabrication includes at least one compatibilizer at generally any concentration. As used herein, “compatibilizer” refers to any material capable of improving the compatibility of immiscible polymers. Any suitable compatibilizer(s) may be used in any embodiment. A compatibilizer may be selected based on its compatibility with each of the polymers in the system; one end of the compatibilizer molecule must be compatible with one of the polymers, and the other end of the compatibilizer molecule must be compatible with the other polymer. In some embodiments, the compatibilizer is a polymer or copolymer that, when added to an immiscible polymer blend, modifies the interfacial character and stabilizes the morphology of the polymer blend. In some embodiments, the at least one compatibilizer includes at least one maleic anhydride modified polymer. In some embodiments, the at least one compatibilizer includes styrene maleic anhydride, polyolefin maleic anhydride, or combinations thereof. In some embodiments, the composition includes about 3 parts by weight of at least one compatibilizer to about 10 parts by weight of at least one compatibilizer. In some embodiments, the composition includes about 5 parts by weight of at least one compatibilizer. In some embodiments, the composition includes about 3 parts by weight of at least one compatibilizer, about 4 parts by weight of at least one compatibilizer, about 5 parts by weight of at least one compatibilizer, about 6 parts by weight of at least one compatibilizer, about 7 parts by weight of at least one compatibilizer, about 8 parts by weight of at least one compatibilizer, about 9 parts by weight of at least one compatibilizer, about 10 parts by weight of at least one compatibilizer, or any value or range of values between any two of these values, including endpoints.

In some embodiments, the composition for fused filament fabrication includes about 100 parts by weight of at least one thermoplastic material, about 3 to about 20 parts by weight of maleic anhydride, about 2 to about 10 parts by weight of at least one fatty acid salt, and about 0.3 to about 3 parts by weight of at least one radical inhibitor. In some embodiments, the composition for fused filament fabrication includes about 100 parts by weight of at least one thermoplastic material, about 3 to about 20 parts by weight of maleic anhydride, about 2 to about 10 parts by weight of at least one fatty acid salt, about 0.3 to about 3 parts by weight of at least one radical inhibitor, and about 1 to about 5 parts by weight of at least one processing aid. In some embodiments, the composition for fused filament fabrication includes about 100 parts by weight of at least one thermoplastic material, about 3 to about 20 parts by weight of maleic anhydride, about 2 to about 10 parts by weight of at least one fatty acid salt, about 0.3 to about 3 parts by weight of at least one radical inhibitor, and about 3 to about 10 parts by weight of at least one compatibilizer. In some embodiments, the composition for fused filament fabrication includes about 100 parts by weight of at least one thermoplastic material, about 3 to about 20 parts by weight of maleic anhydride, about 2 to about 10 parts by weight of at least one fatty acid salt, about 0.3 to about 3 parts by weight of at least one radical inhibitor, about 1 to 5 parts by weight of at least one processing aid, and about 3 to about 10 parts by weight of at least one compatibilizer.

In some embodiments, the composition for fused filament fabrication includes about 100 parts by weight of at least one thermoplastic material, about 5 parts by weight of maleic anhydride, about 6 parts by weight of one or more fatty acid salt, and about 1 part by weight of at least one radical inhibitor. In some embodiments, the composition for fused filament fabrication includes about 100 parts by weight of at least one thermoplastic material, about 5 parts by weight of maleic anhydride, about 6 parts by weight of at least one fatty acid salt, about 1 part by weight of at least one radical inhibitor, and about 3 parts by weight of at least one processing aid. In some embodiments, the composition for fused filament fabrication includes about 100 parts by weight of at least one thermoplastic material, about 5 parts by weight of maleic anhydride, about 6 parts by weight of at least one fatty acid salt, about 1 part by weight of at least one radical inhibitor, and about 5 parts by weight of at least one compatibilizer. In some embodiments, the composition for fused filament fabrication includes about 100 parts by weight of at least one thermoplastic material, about 5 parts by weight of maleic anhydride, about 6 parts by weight of at least one fatty acid salt, about 1 part by weight of at least one radical inhibitor, about 3 parts by weight of at least one processing aid, and about 5 parts by weight of at least one compatibilizer.

In some embodiments, the composition for fused filament fabrication includes at least one thermoplastic material, maleic anhydride, at least one fatty acid salt, and at least one radical initiator, wherein the at least one fatty acid salt includes sodium stearate and zinc stearate. In some embodiments, the composition for fused filament fabrication includes at least one thermoplastic material, maleic anhydride, at least one fatty acid salt, and at least one radical initiator, wherein the at least one fatty acid salt includes about 3 parts by weight of sodium stearate and about 3 parts by weight of zinc stearate.

In some embodiments, the composition for fused filament fabrication includes about 100 parts by weight of at least one thermoplastic material and about 5 to about 30 parts by weight of at least one ionomer. In some embodiments, the composition includes about 100 parts by weight of at least one thermoplastic material, about 5 to about 30 parts by weight of at least one ionomer, and about 1 to about 5 parts by weight of at least one processing aid. In some embodiments, the composition includes about 100 parts by weight of at least one thermoplastic material, about 5 to about 30 parts by weight of at least one ionomer, and about 3 to about 10 parts by weight of at least one compatibilizer. In some embodiments, the composition includes about 100 parts by weight of at least one thermoplastic material, about 5 to about 30 parts by weight of at least one ionomer, about 1 to about 5 parts by weight of at least one processing aid, and about 3 to about 10 parts by weight of at least one compatibilizer.

In some embodiments, the composition for fused filament fabrication includes about 100 parts by weight of at least one thermoplastic material and about 10 parts by weight of at least one ionomer. In some embodiments, the composition includes about 100 parts by weight of at least one thermoplastic material, about 10 parts by weight of at least one ionomer, and about 3 parts by weight of at least one processing aid. In some embodiments, the composition includes about 100 parts by weight of at least one thermoplastic material, about 10 parts by weight of at least one ionomer, and about 5 parts by weight of at least one compatibilizer. In some embodiments, the composition includes about 100 parts by weight of at least one thermoplastic material, about 10 parts by weight of at least one ionomer, about 3 parts by weight of at least one processing aid, and about 5 parts by weight of at least one compatibilizer.

In some embodiments, the composition for fused filament fabrication includes about 100 parts by weight of at least one thermoplastic material and about 5 parts by weight to about 30 parts by weight of at least one copolymer of methacrylic acid and an olefin. In some embodiments, the composition for fused filament fabrication includes about 100 parts by weight of at least one thermoplastic material, about 5 parts by weight to about 30 parts by weight of at least one copolymer of methacrylic acid and an olefin, and about 1 parts by weight to about 5 parts by weight of at least one processing aid. In some embodiments, the composition for fused filament fabrication includes about 100 parts by weight of at least one thermoplastic material, about 5 parts by weight to about 30 parts by weight of at least one copolymer of methacrylic acid and an olefin, and about 3 parts by weight to about 10 parts by weight of at least one compatibilizer. In some embodiments, the composition for fused filament fabrication includes about 100 parts by weight of at least one thermoplastic material, about 5 parts by weight to about 30 parts by weight of at least one copolymer of methacrylic acid and an olefin, about 1 parts by weight to about 5 parts by weight of at least one processing aid, and about 3 parts by weight to about 10 parts by weight of at least one compatibilizer.

In some embodiments, the composition for fused filament fabrication includes about 100 parts by weight of at least one thermoplastic material and about 10 parts by weight of at least one copolymer of methacrylic acid and an olefin. In some embodiments, the composition for fused filament fabrication includes about 100 parts by weight of at least one thermoplastic material, about 10 parts by weight of at least one copolymer of methacrylic acid and an olefin, and about 3 parts by weight of at least one processing aid. In some embodiments, the composition for fused filament fabrication includes about 100 parts by weight of at least one thermoplastic material, about 10 parts by weight of at least one copolymer of methacrylic acid and an olefin, and about 5 parts by weight of at least one compatibilizer. In some embodiments, the composition for fused filament fabrication includes about 100 parts by weight of at least one thermoplastic material, about 10 parts by weight of at least one copolymer of methacrylic acid and an olefin, about 3 parts by weight of at least one processing aid, and about 5 parts by weight of at least one compatibilizer.

In some embodiments, the composition for fused filament fabrication is configured to be extruded into at least one filament. In some embodiments, the composition is configured to be heated to a temperature of about 150° C. to about 300° C. when extruded into the at least one filament. In some embodiments, the composition is configured to be heated to a temperature of about 200° C. to about 250° C. when extruded into the at least one filament. Example temperatures include about 150° C., about 200° C., about 250° C. about 300° C., or any value or range of values between any two of these values, including endpoints.

In some embodiments, the composition for fused filament fabrication is configured to be extruded into at least two layers to create a three dimensional article. In some embodiments, the composition is configured to be heated to a temperature of about 150° C. to about 300° C. when extruded into at least two layers to create a three dimensional article. In some embodiments, the composition is configured to be heated to a temperature of about 200° C. to about 250° C. when extruded into at least two layers to create a three dimensional article. Example temperatures include about 150° C., about 200° C., about 250° C., about 300° C., or any value or range of values between any two of these values, including endpoints.

In some embodiments, the composition for fused filament fabrication includes at least one thermoplastic material and at least one ionomer, and at least one of the at least one thermoplastic material and at least one of the at least one ionomer form an interpenetrating polymer network. By interpenetrating polymer network, it is meant that at least one of the thermoplastic and the ionomer form a polymer network with the thermoplastic/ionmer network of an adjacent layer. In this manner, strong inter-layer bonds are achieved.

In some embodiments, the at least two layers of the article are configured to be crosslinked by ionic bond formation. In some embodiments, the at least two layers of the article are configured to be crosslinked by hydrogen bond formation. In some embodiments, the at least two layers of the article are configured to form an interpenetrating polymer network. As used herein, “interpenetrating polymer network” refers to a polymer comprising two or more networks which are at least partially interlaced on a polymer scale but not covalently bonded to each other. The network cannot be separated unless chemical bonds are broken.

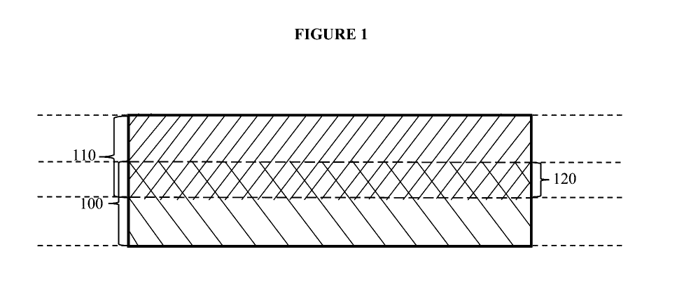

FIG. 1 shows a cross-sectional view of a 3-dimensional article having two layers prepared in accordance with some embodiments. A second layer 110 is deposited atop the first layer 100, forming a bonding region 120 in which the layers are crosslinked by ionic bond formation, hydrogen bond formation, and/or the formation of an interpenetrating polymer network. The bonding region 120 between the first layer 100 and the second layer 110 is depicted generally in FIG. 1. However, the actual bonding may be outside of the bonding region 120, as the bonding does not have a specifically defined border and is not limited to bonding region 120. Each layer may be the same thickness or a different thickness, and may be oriented in a parallel or non-parallel manner. The crosslinking functions to strengthen the interlayer bonds within the 3-dimensional article.

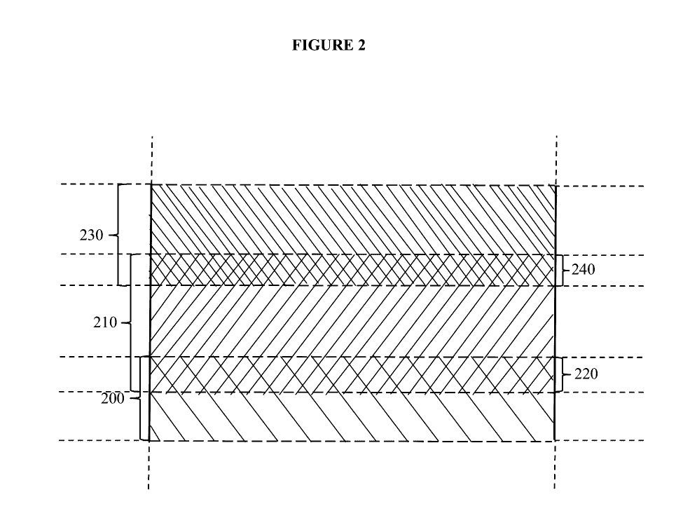

In some embodiments, a 3-dimensional article may have more than two layers, wherein each layer is deposited in contact with at least a portion of one or more of the previously deposited layers, forming a bonding region. In some embodiments, crosslinking in the bonding region occurs by ionic bond formation, hydrogen bond formation, and/or the formation of an interpenetrating polymer network. The crosslinking functions to strengthen the interlayer bonds within the 3-dimensional article. Each layer may be the same thickness or a different thickness, and may be oriented in a parallel or non-parallel manner. FIG. 2 shows a cross-sectional view of a 3-dimensional article having more than two layers prepared in accordance with some embodiments. A layer 210 is deposited atop a previously-deposited layer 200, forming a bonding region 220 in which the layer 210 and layer 200 may be crosslinked by ionic bond formation, hydrogen bond formation, and/or the formation of an interpenetrating polymer network. Another layer 230 may be deposited atop layer 210, forming another bonding region 240 in which the layer 210 and the layer 230 may be crosslinked by ionic bond formation, hydrogen bond formation, and/or the formation of an interpenetrating polymer network. The bonding region 220 and the bonding region 240 are depicted generally in FIG. 2. However, the actual bonding may be outside of the bonding region 220 and/or the bonding region 240, as the bonding does not have a specifically defined border and is not limited to bonding region 220 and/or bonding region 240. The process of depositing a layer atop the previous layer is repeated for the desired number of layers, wherein each layer deposited atop the previous layer forms a bonding region with the previous layer.

### EXAMPLES

### Example 1: Ionomer-Grafted Acrylonitrile Butadiene Styrene

To prepare an ionomer-grafted acrylonitrile butadiene styrene, first the following components are mixed: 100 parts by weight of acrylonitrile butadiene styrene, 5 parts by weight of maleic anhydride, 3 parts by weight of sodium stearate, 3 parts by weight of zinc stearate, and 1 part by weight of di-t-butyl peroxide. The mixture of these ingredients is then heated to about 250° C. and extruded into filaments.

Acrylonitrile butadiene styrene can be grafted with maleic anhydride with a radical initiator. In this example, at the same time the maleic anhydride is initialized for grafting to acrylonitrile butadiene styrene by the radical initiator di-t-butyl peroxide, maleic anhydride reacts with the sodium stearate to form an ionomer. The addition of zinc stearate provides zinc as a divalent ion bridge, strengthening the ionomer.

When the resulting filaments are used in fused filament fabrication, the surface of the existing previously deposited layer will be heated up by contact with a new deposit, prompting ionic bond formation across the interface, resulting in interlayer crosslinking.

### Example 2: Acrylonitrile Butadiene Styrene-Ionomer Interpenetrating Polymer Network

To prepare an acrylonitrile butadiene styrene-ionomer interpenetrating polymer network, first the following components are mixed: 100 parts by weight of acrylonitrile butadiene styrene, 10 parts by weight Surlyn® 8920 sodium ionomer resin (DuPont), and 2 parts by weight of calcium stearate. The mixture of these ingredients is then heated to about 250° C. and extruded into filaments.

Acrylonitrile butadiene styrene and Surlyn® 8920 sodium ionomer resin can be blended because they have similar solubility parameters. These two polymers are not covalently linked. When ionic crosslinking occurs among Surlyn® 8920 ionomer molecules, the two polymers will form an interpenetrating polymer network.

When the resulting filaments are used in fused filament fabrication, the surface of the existing previously deposited layer will be heated up by contact with a new deposit, prompting ionic bond formation across the interface, resulting in interlayer crosslinking.

### Example 3: Acrylonitrile Butadiene Styrene-Polyacid Interpenetrating Polymer Network

To prepare an acrylonitrile butadiene styrene-polyacid interpenetrating polymer network, first the following components are mixed: 100 parts by weight of acrylonitrile butadiene styrene, 10 parts by weight of Nucrel® 960 ethylene and methacrylic acid copolymer (DuPont), and 2 parts by weight of calcium stearate. The mixture of these ingredients was then heated to about 250° C. and extruded into filaments.

Acrylonitrile butadiene styrene and Nucrel® 960 copolymer can be blended because they have similar solubility parameters. These two polymers are not covalently linked. When hydrogen bonding occurs among Nucrel® 960 copolymer molecules, the two polymers will form an interpenetrating polymer network.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to.” the term “having” should be interpreted as “having at least.” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone. A and B together. A and C together, B and C together, and/or A. B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, and so forth. As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A composition for fused filament fabrication comprising:
at least one thermoplastic material;
maleic anhydride;
at least one fatty acid salt; and
at least one radical initiator.

2. The composition of claim 1, wherein the at least one thermoplastic material comprises acrylonitrile-butadiene styrene, poly lactic acid, polyolefin, polyamide, polycarbonate, polyphenylsulfone, polyetherimide, or combinations thereof.

3. (canceled)

4. The composition of claim 1, wherein the at least one fatty acid salt comprises sodium stearate, zinc stearate, calcium stearate, magnesium stearate, or combinations thereof.

5. (canceled)

6. The composition of claim 1, wherein the at least one radical initiator includes di-t-butyl peroxide.

7. The composition of claim 1, wherein the composition comprises:
about 100 parts by weight of the at least one thermoplastic material;
about 3 to about 20 parts by weight of maleic anhydride;
about 2 to about 10 parts by weight of the at least one fatty acid salt; and
about 0.3 to about 3 parts by weight of the at least one radical inhibitor.

8. The composition of claim 1, wherein the composition comprises:
about 100 parts by weight of the at least one thermoplastic material;
about 5 parts by weight of maleic anhydride;
about 6 parts by weight of the at least one fatty acid salt; and
about 1 part by weight of the at least one radical inhibitor.

9. (canceled)

10. The composition of claim 1, further comprising at least one processing aid.

11. The composition of claim 10, wherein the at least one processing aid comprises sodium stearate, calcium stearate, magnesium stearate, zinc stearate, paraffin wax, or combinations thereof, and wherein the at least one processing aid is present in the composition in an amount of about 1 to about 5 parts by weight.

12.-13. (canceled)

14. The composition of claim 1, further comprising at least one compatibilizer.

15. (canceled)

16. The composition of claim 14, wherein the at least one compatibilizer comprises styrene maleic anhydride, polyolefin maleic anhydride, or combinations thereof, wherein the compatibilizer is present in the composition in an amount of about 3 to about 10 parts by weight.

15.-25. (canceled)

26. An article comprising a plurality of layers, wherein at least one layer is formed by depositing a composition for fused filament fabrication, comprising:
at least one thermoplastic material;
maleic anhydride;
at least one fatty acid salt; and
at least one radical initiator.

27. The article of claim 26, wherein at least two layers are crosslinked by ionic bond formation.

28. The article of claim 26, wherein the at least one thermoplastic material comprises acrylonitrile-butadiene styrene, poly lactic acid, polyolefin, polyamide, polycarbonate, polyphenylsulfone, polyetherimide, or combinations thereof.

29. (canceled)

30. The article of claim 26, wherein the at least one fatty acid salt comprises sodium stearate, zinc stearate, calcium stearate, magnesium stearate, or combinations thereof.

31. (canceled)

32. The article of claim 26, wherein the at least one radical initiator is di-t-butyl peroxide.

33. The article of claim 26, wherein the composition comprises:
about 100 parts by weight of the at least one thermoplastic material;
about 3 to about 20 parts by weight of maleic anhydride;
about 2 to about 10 parts by weight of the at least one fatty acid salt; and
about 0.3 to about 3 parts by weight of the at least one radical inhibitor.

34.-35.

36. The article of claim 26, wherein the composition further comprises at least one processing aid.

37. The article of claim 36, wherein the at least one processing aid comprises sodium stearate, calcium stearate, magnesium stearate, zinc stearate, paraffin wax, or combinations thereof, and wherein the at least one processing aid is present in the composition in an amount of about 1 to about 5 parts by weight.

38.-39. (canceled)

40. The article of claim 26, wherein the composition further comprises at least one compatibilizer.

41. (canceled)

42. The article of claim 40, wherein the at least one compatibilizer comprises styrene maleic anhydride, polyolefin maleic anhydride, or combinations thereof, wherein the compatibilizer is present in the composition in an amount of about 3 to about 10 parts by weight.

43.-50. (canceled)

51. A method of preparing an article comprising:
depositing a plurality of layers to form an article, wherein at least one layer comprises a composition comprising:
at least one thermoplastic material;
maleic anhydride;
at least one fatty acid salt; and
at least one radical initiator.

52. (canceled)

53. The method of claim 51, wherein depositing the at least one layer comprises depositing a composition having a thermoplastic material including acrylonitrile-butadiene styrene, poly lactic acid, polyolefin, polyamide, polycarbonate, polyphenylsulfone, polyetherimide, or combinations thereof.

54. (canceled)

55. The method of claim 51, wherein the depositing at least one layer comprises depositing a composition having at least one fatty acid salt including sodium stearate, zinc stearate, calcium stearate, magnesium stearate, or combinations thereof.

56. (canceled)

57. The method of claim 51, wherein the depositing the at least one layer comprises depositing a composition having at least one radical initiator including di-t-butyl peroxide.

58. The method of claim 51, wherein depositing the at least one layer comprises depositing a composition comprising:
about 100 parts by weight of the at least one thermoplastic material;
about 3 to about 20 parts by weight of maleic anhydride;
about 2 to about 10 parts by weight of the at least one fatty acid salt; and
about 0.3 to about 3 parts by weight of the at least one radical inhibitor.

59.-60. (canceled)

61. The method of claim 51, wherein depositing the at least one layer comprises depositing a composition further comprising at least one processing aid.

62. The method of claim 51, wherein depositing the at least one layer comprises depositing a composition further comprising at least one processing aid including sodium stearate, calcium stearate, magnesium stearate, zinc stearate, paraffin wax, or combinations thereof, wherein the at least one processing aid is present in the composition in an amount of about 1 to about 5 parts by weight.

63.-64. (canceled)

65. The method of claim 51, wherein depositing the at least one layer comprises depositing a composition further comprising at least one compatibilizer.

66. (canceled)

67. The method of claim 51, wherein depositing the at least one layer comprises depositing a composition further comprising at least one compatibilizer including styrene maleic anhydride, polyolefin maleic anhydride, or combinations thereof, wherein the compatibilizer is present in the composition in an amount of about 3 to about 10 parts by weight.

68.-69. (canceled)

70. The method of claim 51, further comprising extruding the composition into at least one filament.

71.-72. (canceled)

73. The method of claim 51, further comprising extruding the composition into a plurality of layers to create a three dimensional article.

74.-210. (canceled)
